(19) United States
(12) Patent Application Publication
(10) Pub. No.: US 2024/0279121 A1
(43) Pub. Date: Aug. 22, 2024

(54) ENERGY-SAVING AND ENVIRONMENT-FRIENDLY NON-AUTOCLAVED PIPE PILE CONCRETE MATERIAL WITH HIGH IMPACT RESISTANCE AND PREPARATION METHOD THEREOF

(71) Applicant: GUANGDONG UNIVERSITY OF TECHNOLOGY, GUANGZHOU (CN)

(72) Inventors: ZHE XIONG, GUANGZHOU (CN); SHENG LAN, GUANGZHOU (CN); ZHEN FANG, GUANGZHOU (CN); FENG LIU, GUANGZHOU (CN); LIJUAN LI, GUANGZHOU (CN)

(21) Appl. No.: 18/653,997

(22) Filed: May 3, 2024

Related U.S. Application Data
(63) Continuation of application No. PCT/CN2023/082844, filed on Mar. 21, 2023.

(30) Foreign Application Priority Data
Jul. 4, 2022 (CN) 202210765128.1

(51) Int. Cl. C04B 28/04; C04B 14/06; C04B 18/22; C04B 20/04; C04B 28/08; C04B 103/30; C04B 111/00; C04B 111/56

(52) U.S. Cl. CPC C04B 28/04; C04B 14/06; C04B 18/22; C04B 20/04; C04B 28/08; C04B 2103/302; C04B 2111/00017; C04B 2111/56; C04B 2201/50

(57) ABSTRACT

Provided are an energy-saving and environment-friendly non-autoclaved pipe pile concrete material with high impact resistance, and a preparation method thereof. Raw materials of the concrete include cementing material, sand and gravels, modified rubber fiber, water reducer and water. The rubber fiber comes from waste tires. The cementing material includes cement, slag powder and silicon powder. A content of the cementing material in the concrete is 400-500 kg/m³. A water-cement ratio is 0.19-0.22. A specific surface area of the slag powder is 400-450 m²/kg. A content ratio of the slag power to the whole cementing material by mass is 25-40%. A specific surface area of the silicon powder is 15-30 m²/kg. A content ratio of the silicon power to the whole cementing material by mass is 5-10%. The modified rubber fiber is obtained by making the rubber fiber undergo shallow carbonization and soaking the obtained rubber fiber with a modifier.

### CROSS-REFERENCING OF RELEVANT APPLICATIONS

This application is a continuation of International Application No. PCT/CN2023/082844, filed on Mar. 21, 2023, which claims priority to Chinese Patent Application No. 202210765128.1, field on Jul. 4, 2022, both of which are herein incorporated by reference in their entireties.

### TECHNICAL FIELD

The present disclosure relates to the field of environment-friendly and energy-saving building materials, in particular to an energy-saving and environment-friendly non-autoclaved pipe pile concrete material with high impact resistance (that is, a non-autoclaved concrete material that is energy-saving and environment-friendly, has high impact resistance, and used for pipe piles) and a preparation method thereof.

### BACKGROUND

With the continuous advancement of the modernization of China's construction industry, the demand for pre-stressed high-strength concrete (PHC) pipe piles is increasing, and energy-saving non-autoclaved concrete pipe piles have been widely concerned. Natural gas and coal are mainly consumed in the production of PHC pipe piles. Based on the standard of “Evaluation Methods and Requirements for Low-carbon Products of Ready-mixed Concrete (T/CBMF 27-2018), the total carbon emission of the production of non-autoclaved concrete pipe piles is 339.5 kg/m³, which is about 20% lower than the total carbon emission of the production of autoclaved concrete pipe piles, and it has a very significant effect of energy saving and emission reduction.

However, due to the brittleness of high-strength concrete, the impact resistance of the non-autoclaved concrete pipe piles is weak, which cannot adapt to projects that may bear impact load, such as airport runways and highway piers. In order to improve the impact resistance of the non-autoclaved concrete pipe piles, based on the related research results of the rubber concrete, our research group tried to add rubber particles and rubber fibers into non-autoclaved concrete, which can improve the crack resistance and impact resistance of the concrete.

In addition, these rubber particles are all from waste tires, and the rubber contained in the waste tires is difficult to degrade under natural conditions. With the increase of the number of waste tires year by year, the environment problem caused by them is becoming increasingly prominent. After crushing the waste tire rubber into rubber particles and rubber fibers, such rubber particles and rubber fibers may be added into pipe pile concrete, this can not only improve the impact resistance of the non-autoclaved pipe piles, but also alleviate the pressure caused by waste tires on the environment, thus truly achieving environmental protection.

However, through a lot of research, it is found that the addition of rubber can improve the toughness of the concrete, but it also reduces the strength of the concrete. Pre-stressed high-strength concrete pipe piles require high strength of the concrete materials, and the specified strength grade must be greater than 80 MPa. Simply pursuing the impact resistance would not meet the strength requirements. The poor surface bonding between rubber and cement is an important reason for the decrease of the strength of the rubber concrete. In order to improve the bonding performance of rubber and cement, a large number of scholars modified the rubber particles before adding them into the cement, such modification includes washing, soaking in NaOH solution, soaking in styrene-butadiene latex, etc. These measures have a positive effect on slowing down the strength loss of the rubber concrete, but most of their research are directed at ordinary concrete, lacking the related research on high-strength concrete. Further, most of these measures adopt a single method, and have a limited improvement effect. In addition, some pretreatment methods would introduce other chemicals, which change the acidity or alkalinity, water-cement ratio of the concrete, etc., and affect the working performance of the concrete, not meeting the needs of rubber-modified non-autoclaved pipe pile concrete (that is, non-autoclaved concrete that is used for pipe piles and contains modified rubber therein).

In view of the shortcomings of the related art, it is necessary to provide an energy-saving and environment-friendly non-autoclaved pipe pile concrete material with high impact resistance and a preparation method thereof to overcome the shortcomings of the related art.

### SUMMARY

In order to solve the above problems, the present disclosure aims to provide an energy-saving and environment-friendly non-autoclaved pipe pile concrete material with high impact resistance and a preparation method thereof.

The object of the present disclosure is achieved by the following technical schemes.

An energy-saving and environment-friendly non-autoclaved pipe pile concrete with high impact resistance is provided. Raw materials of the concrete include a cementing material, sand and gravels, modified rubber fiber, water reducer and water.

The cementing material include cement and admixture, a content of the cementing material in the concrete is 400-500 kg/m³, preferably 470 kg/m³. A water-cement ratio is 0.19-0.22. The admixture includes slag powder and silicon powder, preferably S95-grade slag powder and imported 98 silicon powder. A specific surface area of the slag powder is 400-450 m²/kg, preferably 412m²/kg. A content ratio of the slag power to the whole cementing material by mass is 25-40%, preferably 30%. A specific surface area of the silicon powder is 15-30 m²/kg, preferably 21m²/kg. A content ratio of the silicon power to the whole cementing material by mass is 5-10%, preferably 10%.

A content of the sand and gravels in the concrete is 1784 kg/m³-1925 kg/m³, where a sand content of the sand and gravels is 31.6%-36.6%.

A content ratio of the water reducer to the whole cementing material by mass is 1.0-1.5%, preferably 1.2%.

In the above cementing material, the cement is P. II 42.5R Portland cement produced by China Resources Cement Co., Ltd. The water reducer is QL-PC5 polycarboxylic acid high efficiency water reducer produced by Jiangmen Qiangli Building Materials Technology Co., Ltd., with a solid content of 40%. The sand is medium sand in zone II with a fineness modulus of 2.8.

The rubber fiber is obtained by mechanically cutting a waste rubber tire. The rubber fiber has a length-diameter ratio of 2-10, preferably 5, a diameter of 2 mm-10 mm, and a tensile strength of 20-25 MPa. The rubber fiber is added to replace the sand and gravels of an equal volume, with a replacement rate of 5-20%, preferably 15%.

Preferably, the rubber fiber is modified. Further, the modified rubber fiber is prepared by a method including the following steps:
(1) weighing a certain amount of rubber fiber, soaking the rubber fiber in clear water to wash off impurities and additives on a surface of the rubber fiber, filtering and drying the rubber fiber;
(2) placing the dried rubber fiber into a vacuum tube type atmosphere furnace, introducing nitrogen to replace air within the furnace, rapidly raising a temperature to 300-400 degrees Celsius, and keeping the temperature for 10-30 min, then collecting, after cooling, the rubber fiber after shallow carbonization; and
(3) placing the rubber fiber after shallow carbonization into a prepared modifier material for soaking for a certain time, and collecting, after washing and drying, the rubber fiber after secondary modification.

The shallow carbonization means that the carbonization depth is 1/6-1/5 of the radius from the surface to the center of the rubber fiber.

The modifier is one or more selected from NaOH, methanol, silane coupling agent, styrene-butadiene latex and emulsified asphalt. The time for the soaking is preferably 24 h.

Preferably, a mass concentration of NaOH solution is 2-8%. A mass concentration of methanol solution is 65-80%. The silane coupling agent (KH550) is produced by Nanjing Shuguang Chemical Plant, and a content ratio of the added silane coupling agent to the rubber fiber is 2-5% by mass, preferably 3%. The styrene-butadiene latex is hydroxyl styrene-butadiene latex produced by TRINSEO Company of the United States, and a content ratio of the added styrene-butadiene latex to the rubber fiber is 50%-150% by mass, preferably 80%. The emulsified asphalt is cationic slow-cracking emulsified asphalt produced by Guangdong Maoming Xinda Highway Material Co., Ltd., and a content ratio of the added emulsified asphalt to the rubber fiber is 50%-150%.

The present disclosure also provides a method for preparing an energy-saving and environment-friendly non-autoclaved pipe pile concrete with high impact resistance, and the method includes the following steps:
(1) drying the sand and gravels to make a water content of the sand and gravels lower than 2%;
(2) weighing the sand and gravels, Portland cement, slag powder, silicon powder, modified rubber fiber, water reducer and water, according to parts of the raw materials;
(3) pouring aggregate mixture of the sand and gravels, the cement, the slag powder, the silicon powder and the modified rubber fiber into a mixer and stirring them evenly for 60-90 s; this step is mainly used to make the rubber fiber stirred well, to avoid conglomeration when encountering water;
(4) adding the weighed water reducer and water after the aggregate mixture is evenly stirred, and continuing to stir for 120-150 s;
(5) placing the obtained concrete into an iron mold, and standing in a shade for 5-8 h;
(6) placing the concrete obtained in step (5) into a steam pool with an initial temperature of about 50 degrees Celsius, then heating and maintaining a constant temperature environment for 12 h; and
(7) after the temperature of the steam pool drops, opening the pool and taking out the non-autoclaved concrete.

In the above preparation method, a curing time during which the non-autoclaved pipe pile concrete is cured with formwork is 12-13 h. The curing of the concrete with formwork includes a delaying curing phase, a temperature-increasing phase and a constant temperature phase. The duration of the delaying curing phase is not less than 5 h. The duration of the temperature-increasing phase is not less than 2 h. The constant temperature of the constant temperature phase is 85-90 degrees Celsius, and the duration of the constant temperature phase is not less than 10 h.

### BRIEF DESCRIPTION OF THE DRAWINGS

FIG. 1 illustrates failure modes of quasi-static splitting of samples of comparative example 1, embodiment 1, embodiment 4, embodiment 5, embodiment 6 and embodiment 7, respectively.

FIG. 2 illustrates failure modes of dynamic splitting of samples in comparative example 1, embodiment 1, embodiment 4, embodiment 5, embodiment 6 and embodiment 7, respectively.

### DETAILED DESCRIPTION OF EMBODIMENTS

The present disclosure is further described in detail in combination with particular embodiments, but the implementations of the present disclosure is not limited to thereto. For the process parameters not specified, reference may be made to the conventional technology.

### Comparative Example 1

A non-autoclaved pipe pile concrete with impact resistance includes the following raw materials by weight per cubic meter:
a cementing material of 470 kg, which consists of Portland cement, slag powder and silicon powder. The Portland cement is China Resources P II 42.5R Portland cement, accounting for 60% of the total mass of the cementing material. The slag powder is S95-grade fine slag powder with a specific surface area of 412 m²/kg. The slag powder can improve the subsequent strength of the non-autoclaved concrete, and its mass accounts for 30% of the total mass of the cementing material. The silicon powder is imported 98 silicon powder with a specific surface area of 21 m²/kg, and its mass accounts for 10% of the total mass of the cementing material;
sand and gravels of 1819.25 kg, with a sand content of 32.9%;
rubber fiber, which has a length of 50 mm, a diameter of 10 mm, a volume accounting for 15% of the volume of aggregate, and a mass of 27.12 kg. The aggregate is composed of the sand and gravels and the rubber fiber;
water reducer of 5.64 kg, the water reducer is QL-PC5 polycarboxylic acid high efficiency water reducer with a solid content of 40%, and the mass of the water reducer is 1.2% of the total mass of the cementing material;
water of 100 kg.

The preparation method thereof includes the following steps:
(1) drying the sand and gravels, to make a water content of the sand and gravels lower than 2%;
(2) weighing the sand and gravels, Portland cement, slag powder, silicon powder, rubber fiber, water reducer and water, according to the parts of the raw materials;
(3) pouring the sand and gravels, the Portland cement, the slag powder, the silicon powder and the rubber fiber weighed in step (2) into a mixer in sequence, and stirring them for 90 s; this step is mainly used to make the rubber fiber stirred well in advance, to avoid conglomeration when encountering water;
(4) pouring the water reducer and the water into the mixer, and continue to stir for 150 s;
(5) measuring the slump as 38 mm, after the stirring;
(6) pouring the obtained non-autoclaved pipe pile concrete mixture into a prepared iron mold, and standing in the shade for 5 h;
(7) placing the concrete obtained in step (6) into a steam pool with an initial temperature of about 50 degrees Celsius;
(8) covering the pool with a lid, introducing steam to raise the temperature in the pool to 85-90 degrees Celsius after 2 h, and keeping the temperature for 12 h; and
(9) when the temperature in the pool drops back to 50 degrees Celsius, taking off the lid and taking out the concrete.

Under such contents, the demoulding strength of the rubber-modified non-autoclaved concrete is 73 MPa, which does not meet the strength requirements of pre-stressed high-strength pipe pile concrete, see Table 1.

### Comparative Example 2

A rubber fiber modified non-autoclaved pipe pile concrete, in which the rubber fiber is modified with KH550 silane coupling agent, includes the following raw materials by weight per cubic meter:

cementing material, water reducer, sand and gravels, rubber fiber, and water, which are the same as in those in comparative example 1.

The rubber fiber is modified with a method including the following steps:
(1) weighing the rubber fiber, soaking the rubber fiber in clear water to wash off impurities and additives on the surface of the rubber fiber, filtering and drying the rubber fiber; and
(2) weighing the KH550 silane coupling agent of 0.54 kg, which accounts for 2% of the rubber fiber by mass, and dissolving the silane coupling agent with water at 70-80 degrees Celsius; placing the rubber fiber into the aqueous solution of the silane coupling agent, stirring the rubber fiber evenly and making it soaked for 12 h; and finally putting the rubber fiber in a dry and ventilated environment for 24 h until the surface of the rubber fiber is completely dry for use.

The preparation method of the concrete is the same as that of comparative example 1, whereas the slump measured in step (5) after stirring is 22 mm. The demoulding strength is 76 MPa, which is 4.2% higher than that without modification.

There is a good modification effect when the silane coupling agent is used alone to modify the rubber fiber. That is because K550 silane coupling agent contains aminopropyl and ethoxy group, where the aminopropyl and the rubber are chemically bonded, and the ethoxy group and the carboxyl group in the cement mortar produce Si—O—Si bonds through dehydration synthesis. The coupling agent plays a bridging role, which enable the organic material of the rubber and the inorganic cementing material of the cement to be well bonded together. Other parameters are illustrated in Table 1.

### Comparative Example 3

A rubber fiber modified non-autoclaved pipe pile concrete, in which the rubber fiber is modified with styrene-butadiene latex, includes the following raw materials by weight per cubic meter:

cementing material, water reducer, sand and gravels, rubber fiber, and water, which are the same as in those in comparative example 1.

The rubber fiber is modified with a method including the following steps:
(1) weighing the rubber fiber, soaking the rubber fiber in clear water to wash off impurities and additives on the surface of the rubber fiber, filtering and drying the rubber fiber; and
(2) weighing the styrene-butadiene latex of 21.6 kg, which accounts for 80% of the rubber fiber by mass, placing the rubber fiber into the styrene-butadiene latex, stirring the rubber fiber evenly and soaking it for 24 h, then baking the rubber fiber at 100 degrees Celsius for 1.5 h to ensure that the latex loses fluidity, and collecting the rubber fiber for later use.

The preparation method of the concrete is the same as that of comparative example 1, whereas the slump measured in step (5) after stirring is 42 mm. The demoulding strength is 78.1 MPa, which is 7.0% higher than that without modification.

The modification effect of the styrene-butadiene latex is good. That is because styrene-butadiene latex has good compatibility with tire rubber, where the carboxyl groups in the molecular chain of the styrene-butadiene latex can form ionic bonds with calcium ions in the cement mortar for chemical adsorption. In addition, the styrene-butadiene latex, as an auxiliary cementing material, functions like a water reducer when the concrete is stirred, which can improve the fluidity of the cement mortar to a certain extent and is beneficial to improve the strength of rubber concrete. Other parameters are illustrated in Table 1.

### Embodiment 1

A rubber fiber modified non-autoclaved pipe pile concrete, in which the fiber is modified through shallow carbonization, includes the following raw materials by weight per cubic meter:
cementing material, water reducer, sand and gravels, rubber fiber, and water, which are the same as in those in comparative example 1.

The method for modifying the rubber fiber through shallow carbonization includes the following steps:
(1) weighing the rubber fiber, soaking the rubber fiber in clear water to wash off impurities and additives on the surface of the rubber fiber, filtering and drying the rubber fiber; and
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling. It was tested that a carbonized layer is only at 1/6-1/5 of the radius from the surface to the center of the rubber fiber.

The preparation method of the concrete is the same as that of comparative example 1, whereas the slump measured in step (5) after stirring is 13 mm. The demoulding strength reaches 80.3 MPa. The modification effect of the shallow carbonization on the rubber fiber is better than those of the single silane coupling agent and the styrene-butadiene latex, and the strength of the concrete is improved by about 10% compared with that without carbonization.

This is because the shallow carbonization changes the hydrophobicity of the rubber, greatly reduces the acidity at the surface of the rubber fiber, and defines a pore structure, which increases the contact area with the cement mortar, thus greatly improving the bonding performance. Other parameters are illustrated in Table 1.

### Embodiment 2

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) placing the rubber fiber after shallow carbonization into a prepared NaOH solution with a mass concentration of 2%, for soaking for 24 h, and then taking out the rubber fiber and washing off residual solution therefrom, and drying the rubber fiber for later use.

The preparation method of the concrete is the same as that of embodiment 1, whereas the slump measured in step (5) after stirring is 22 mm. The demoulding strength is 82.7 MPa, which is 13.3% higher than that without modification.

The modification effect of the combination of the shallow carbonization and NaOH solution is stronger than the modification effect of the shallow carbonization alone. That is because NaOH can remove the residual additives such as zinc stearate in the carbonized layer and convert the polymer additives into soluble sodium salt, thus improving the bonding performance between the rubber fiber and the cement mortar. Other parameters are illustrated in Table 1.

### Embodiment 3

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) placing the rubber fiber after shallow carbonization into a prepared methanol solution with a mass concentration of 80%, for soaking for 24 h, and then taking out the rubber fiber and washing off residual solution therefrom, and drying the rubber fiber for later use.

The preparation method of the concrete is the same as that of comparative example 1, whereas the slump measured in step (5) after stirring is 28 mm. The demoulding strength is 83.1 MPa, which is 13.8% higher than that without modification.

The modification effect of the combination of the shallow carbonization and methanol solution is stronger than the modification effect of the shallow carbonization alone. That is because the methanol, the rubber fiber and the carbonized layer are all organic substances, where the methanol can release, swell and erode the carbonized layer and some exposed rubber, which makes the surface of the carbonized rubber fiber rougher and thus enhances the adhesion and compatibility between the rubber fiber and the cement mortar. Other parameters are illustrated in Table 1.

### Embodiment 4

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing KH550 silane coupling agent of 0.54 kg, which accounts for 2% of the rubber fiber by mass, and dissolving the silane coupling agent with water at 70-80 degrees Celsius; placing the rubber fiber after shadow carbonization into the aqueous solution of the silane coupling agent, stirring the rubber fiber evenly and making it soaked for 12 h; and finally putting the rubber fiber in a dry and ventilated environment for 24 h until the surface of the rubber fiber is completely dry for use.

The preparation method of the concrete is the same as that of comparative example 1, whereas the slump measured in step (5) after stirring is 25 mm. The demoulding strength is 85.5 MPa, which is 17.1% higher than that without modification.

The modification effect of the combination of the shallow carbonization and silane coupling agent is stronger than the sum of the modification effect of the shallow carbonization alone and the modification effect of the single silane coupling agent alone. This shows that the combination of the shallow carbonization and the silane coupling agent does not simply superpose the modification effects of the two, and the shallow carbonization and the silane coupling agent produce a synergistic effect. This is because K550 silane coupling agent contains aminopropyl and ethoxy. When rubber fiber is mixed with silane coupling agent through stirring, the ethoxy, as a hydrolyzable group, decomposes when it meets water, which has good reactivity with the carbonized layer of the rubber fiber. In addition, the ethoxy and the carboxyl group in the cement mortar produce Si—O—Si bonds through dehydration synthesis, which makes a monolayer formed at the interface between the cement and the rubber fiber after shallow carbonization, thereby improving the bonding performance therebetween. In addition, a part of the silane coupling agent contacts with the rubber through the pore structure of the carbonized layer, and aminopropyl in the K550 silane coupling agent and the rubber are chemically bonded, which further strengthens the performance at the interface. Under the synergistic effect of the carbonized layer and the monolayer at the interface, the rubber fiber and the cement mortar can be well bonded together. Other parameters are illustrated in Table 1.

### Embodiment 5

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing the KH550 silane coupling agent of 0.81 kg, which accounts for 3% of the rubber fiber by mass, and dissolving the silane coupling agent with water at 70-80 degrees Celsius; placing the rubber fiber after shadow carbonization into the aqueous solution of the silane coupling agent, stirring the rubber fiber evenly and making it soaked for 12 h; and finally putting the rubber fiber in a dry and ventilated environment for 24 h until the surface of the rubber fiber is completely dry for use.

The preparation method of the concrete is the same as that of comparative example 1, whereas the slump measured in step (5) after stirring is 22 mm. The demoulding strength is 86.1 MPa, which is 17.9% higher than that without modification.

The proper increase of the content of the silane coupling agent can improve the bonding performance between the carbonized layer of the rubber and the cement mortar. Other parameters are illustrated in Table 1.

### Embodiment 6

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing the KH550 silane coupling agent of 1.35 kg, which accounts for 5% of the rubber fiber by mass, and dissolving the silane coupling agent with water at 70-80 degrees Celsius; placing the rubber fiber after shadow carbonization into the aqueous solution of the silane coupling agent, stirring the rubber fiber evenly and making it soaked for 12 h; and finally putting the rubber fiber in a dry and ventilated environment for 24 h until the surface of the rubber fiber is completely dry for use.

The preparation method of the concrete is the same as that of comparative example 1, whereas the slump measured in step (5) after stirring is 17 mm. The demoulding strength is 82.3 MPa, which is 12.7% higher than that without modification.

Too much silane coupling agent would cause the monolayer between the coupling agent and the cement to be too thick, which would increase the volume of the rubber fiber, and cause the strength to be attenuated due to the increase of the volume, thus affecting the bonding performance. Other parameters are illustrated in Table 1.

### Embodiment 7

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing styrene-butadiene latex of 21.6 kg, which accounts for 80% of the rubber fiber by mass, placing the rubber fiber after shadow carbonization into the styrene-butadiene latex, stirring the rubber fiber evenly and soaking it for 24 h, then baking the rubber fiber at 100 degrees Celsius for 1.5 h to ensure that the latex loses fluidity, and collecting the rubber fiber for later use.

The preparation method of the concrete is the same as that of comparative example 1, whereas the slump measured in step (5) after stirring is 45 mm. The demoulding strength is 83.7 MPa, which is 14.6% higher than that without modification.

The modification effect of the combination of the shallow carbonization and the styrene-butadiene latex is stronger than the modification effect of the shallow carbonization alone and the modification effect of the styrene-butadiene latex alone. That is because the carboxyl group in the styrene-butadiene latex improves the hydrophilicity of the rubber fiber and the carbonized layer thereof; in addition, it fills the tiny pore structure in the carbonized layer of the rubber fiber to strengthen the compatibility therebetween. Furthermore, the carboxyl groups in the molecular chain of the styrene-butadiene latex can form ionic bonds with calcium ions in the cement mortar for chemical adsorption, and the synergistic effect provided by the special structure of the carbonized layer and the carboxylated styrene-butadiene latex gives stronger bonding performance between the rubber and the cement mortar. In addition, the styrene-butadiene latex, as an auxiliary cementing material, functions like a water reducer when the concrete is stirred, and extra styrene-butadiene latex improves the fluidity of the cement mortar to a certain extent, which is beneficial to improve the strength of the rubber concrete. Other parameters are illustrated in Table 1.

### Embodiment 8

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing the styrene-butadiene latex of 32.4 kg, which accounts for 120% of the rubber fiber by mass, placing the rubber fiber after shadow carbonization into the styrene-butadiene latex, stirring the rubber fiber evenly and soaking it for 24 h, then baking the rubber fiber at 100 degrees Celsius for 1.5 h to ensure that the latex loses fluidity, and collecting the rubber fiber for later use.

The preparation method of the concrete is the same as that of comparative example 1, whereas the slump measured in step (5) after stirring is 55 mm. The demoulding strength is 84.3 MPa, which is 15.5% higher than that without modification.

As an auxiliary cementing material, the styrene-butadiene latex further improves the fluidity of the cement mortar after the content of the styrene-butadiene latex is increased, and the strength of the rubber concrete is improved. Other parameters are illustrated in Table 1.

### Embodiment 9

A rubber fiber modified non-autoclaved pipe pile concrete, in which the rubber fiber is modified twice, includes the following raw materials by weight per cubic meter:
cementing material, water reducer, sand and gravels, rubber fiber, and water, which are the same as in those in comparative example 1.

The modification method including shallow carbonization and secondary modification includes the following steps:
(1) weighing the rubber fiber, soaking the rubber fiber in clear water to wash off impurities and additives on the surface of the rubber fiber, filtering and drying the rubber fiber;
(2) placing the dried rubber fiber into a vacuum tube type atmosphere furnace, introducing nitrogen to replace air within the furnace, quickly raising a temperature to 350 degrees Celsius, and keeping the temperature for 30 min, and then collecting the rubber fiber after cooling; where it was tested that a carbonized layer is only at 1/6-1/5 of the radius from the surface to the center of the rubber fiber; and
(3) weighing emulsified asphalt of 21.6 kg, which accounts for 80% of the of rubber fiber by mass, placing the rubber fiber after shadow carbonization into the emulsified asphalt, stirring the rubber fiber evenly and soaking it for 24 h, then baking the rubber fiber at 100 degrees Celsius for 1.5 h to ensure that the emulsified asphalt loses fluidity, and collecting the rubber fiber for use.

The preparation method of the concrete is the same as that of comparative example 1, except that the mass of the cement in step (3) is reduced by 5% and the reduced cement is replaced by the emulsified asphalt. The slump measured in step (5) after stirring is 43 mm. The demoulding strength is 78.0 MPa, which is 6.8% higher than that without modification.

The modification effect of the combination of the shallow carbonization and the emulsified asphalt is weaker than the modification effect of the shallow carbonization alone. This is because the emulsified asphalt contains a lot of polar substances, and the carbon in the carbonized layer belongs to non-polar substances, which will reduce the bonding performance to some extent. Other parameters are illustrated in Table 1.

TABLE 1

| | | Ratio of | | Dynamic |
|---|---|---|---|---|
| | | tensile | | splitting |
| | Demoulding | strength to | Energy | tensile |
| | compressive | compressive | dissipation | failure |
| | strength/Mpa | strength | Ratio | strain |
| Comparative | 73.0 | 0.061 | 0.65 | 0.42 |
| example 1 | | | | |
| Comparative | 76.0 | 0.060 | 0.66 | 0.44 |
| example 2 | | | | |
| Comparative | 78.1 | 0.063 | 0.65 | 0.42 |
| example 3 | | | | |
| Embodiment 1 | 80.3 | 0.063 | 0.69 | 0.51 |
| Embodiment 2 | 82.7 | 0.061 | 0.66 | 0.47 |
| Embodiment 3 | 83.1 | 0.063 | 0.65 | 0.50 |
| Embodiment 4 | 85.5 | 0.064 | 0.71 | 0.58 |
| Embodiment 5 | 86.1 | 0.063 | 0.72 | 0.60 |
| Embodiment 6 | 82.3 | 0.060 | 0.70 | 0.55 |
| Embodiment 7 | 83.7 | 0.066 | 0.67 | 0.53 |
| Embodiment 8 | 84.3 | 0.065 | 0.66 | 0.54 |
| Embodiment 9 | 78.0 | 0.061 | 0.65 | 0.49 |

Note: Energy consumption ratio refers to as a ratio of dissipated energy to total input energy.

In the single modification method, the shallow carbonization can change the surface structure of the rubber fiber and effectively improve the hydrophilicity of the rubber material. The pore structure of the carbonized layer increases the contact area, and improves the bonding strength between the rubber fiber and the cement mortar, which then improves the strength of the rubber concrete.

In the single modification method, the silane coupling agent contains aminopropyl and ethoxy group, where the aminopropyl and the rubber are chemically bonded, and the ethoxy group and the carboxyl group in the cement mortar produce Si—O—Si bonds through dehydration synthesis. The coupling agent plays a bridging role, which enable the organic material of the rubber and the inorganic cementing material of the cement to be bonded together.

In the single modification method, the carboxyl group of the styrene-butadiene latex not only improves the hydrophilicity of the rubber fiber, but also forms ionic bond with the calcium ion of the cement mortar for chemical adsorption. In addition, the styrene-butadiene latex has an effect of the water reducer, which can improve the fluidity of the concrete and further improve the strength of the non-autoclaved rubber concrete.

These single modification methods all have great room for improvement. The present disclosure proposes a dual modification method. First, the surface structure of the rubber fiber is changed through shallow carbonization, to improve the hydrophilicity of the fiber; and then, a secondary modification is performed with various modifiers. From Table 1, it can be seen that the effect of the dual modification is mostly better than those of the single modifications.

The ratio of tensile strength to compressive strength may be used to measure the brittleness index of the concrete material. The greater the ratio of tensile strength to compressive strength, the smaller the brittleness. From Table 1, it can be seen that the brittleness of the rubber-modified non-autoclaved pipe pile concrete is the smallest after the rubber fiber undergoes the dual modification of “shallow carbonization” plus “styrene-butadiene latex”. This is because the styrene-butadiene latex can enhance the fluidity and has certain elasticity itself.

The energy dissipation ratio may represent the energy-dissipating capacity of the rubber-modified non-autoclaved pipe pile concrete under an impact load. The stronger the energy-dissipating capacity, the better the impact toughness of the concrete. From Table 1, it can be seen that the energy dissipation ratio is the highest when the rubber fiber is modified through the combination of “shallow carbonization” and “silane coupling agent”. This is because the silane coupling agent has a good compatibility with each of the rubber, the rubber carbonized layer and the cement, and the silane coupling agent can form chemical bonds with the rubber fiber and the cement matrix, which improves the bonding strength of the rubber fiber and the cement, and improves the impact toughness of the concrete.

The demoulding strength of the non-autoclaved concrete may directly reflect the strength modification effect of each modification method. From Table 1, it can be seen that the effect of modifying the rubber fiber with the combination of “shallow carbonization” and “silane coupling agent” is stronger than the sum of the modification effect of the shallow carbonization alone and the modification effect of the silane coupling agent alone, and the shallow carbonization and the silane coupling agent produce synergistic effect. The strength after the modification is greatly improved, and the strength improvement effect is the best when the silane coupling agent accounts for 3% of the rubber fiber by mass.

When the pipe pile is subjected to an impact load, it often appears a tensile failure first. The dynamic splitting tensile failure strain is used as an index to measure the crack resistance of the concrete. From Table 1, it can be seen that, after the rubber fiber is modified with the combination of “shallow carbonization” and “silane coupling agent”, the tensile failure strain of the rubber-modified non-autoclaved pipe pile concrete is the largest, that is, its crack resistance is the best.

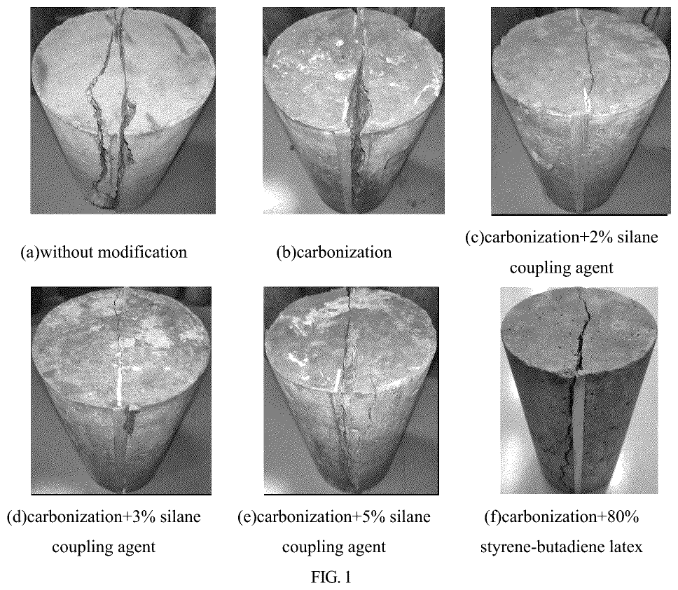

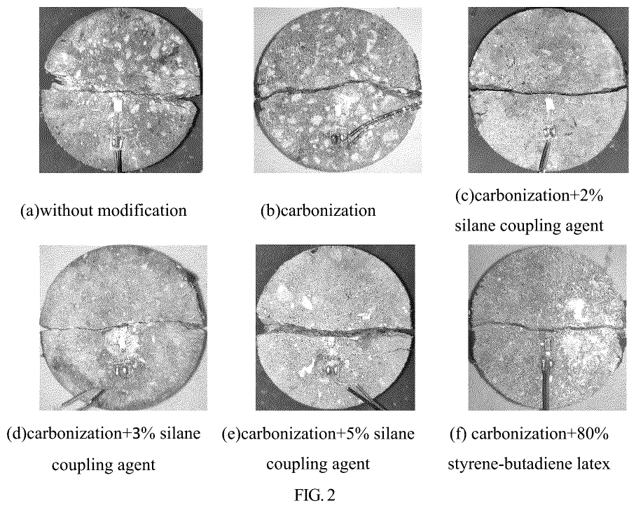

FIG. 1 illustrates failure modes of concrete samples produced with different modification methods, after undergoing quasi-static splitting tensile tests, and FIG. 2 illustrates failure modes of concrete samples produced with different modification methods, after undergoing dynamic splitting tensile tests. Different modification methods result in different failure modes.

As can be seen from FIG. 1, when the rubber fiber was not modified, two large cracks were caused in the quasi-static splitting. After the rubber fiber was modified with the shallow carbonization, there was one splitting crack. After the secondary modification was performed on the carbonized layer, the width of the splitting crack was gradually reduced, and the damage was decreased in degree. Among them, the crack resistance corresponding to the modification method with the combination of “shallow carbonization” and “silane coupling agent” is excellent; in particular, the crack resistance corresponding to the case where the content of the silane coupling agent accounts for 3% of the rubber by mass is the best among the cases where the content of the silane coupling agent accounts for 2%, 3%, and 5% of the rubber by mass.

As can be seen from FIG. 2, when the rubber fiber was not modified, a triangular fractured zone appeared at each of two loading ends of the disc specimen when being subjected to an impact load. This is because the impact energy exceeds the energy absorption capacity of the concrete itself, and more damage is caused to dissipate excess impact energy. After the shallow carbonization of the rubber fiber, the hydrophilicity of the rubber fiber was improved, the bonding interface between the rubber fiber and the cement mortar was improved, and the force transmission performance between the cement mortar and the rubber fiber was improved. This enabled the energy absorption capacity of the rubber fiber to be fully expressed, and the triangular fractured zone was reduced. After the secondary modification was performed on the carbonization layer, the triangular fractured zone disappeared and the width of the crack was decreased. Among them, three modification methods, i.e., the “shallow carbonization”, the combination of “shallow carbonization” and “3% silane coupling agent” and the combination of “shallow carbonization” and “styrene-butadiene latex”, have the smallest width of the through cracks and strong energy consumption capability.

Compared with the prior art, the present disclosure has the following advantages.

(1) The hydrophobicity of the rubber material leads to poor bonding between the rubber material and the cement mortar, which reduces the strength of the concrete. Through the shallow carbonization of the rubber fiber, on one hand, the molecular structure at the surface of the rubber is changed, with C—C bond and C—H bond broken, which alleviates the hydrophobicity. On the other hand, some organic substances in the rubber fiber undergo thermochemical decomposition during the carbonization, which defines a pore structure in the shallow layer, and the carbonized shell with a certain pore structure improves the bonding area between the rubber fiber and the cement mortar. Further, the physical structure and chemical properties of the carbonized layer of the rubber fiber can be changed through the secondary modification by the modifier, so that the bonding between the carbonized layer and the cement mortar is stronger. The strength of the rubber-modified non-autoclaved pipe pile concrete can be improved to the greatest extent, and the rubber fiber can be further added to the concrete to further improve the crack resistance and impact resistance of the non-autoclaved concrete.

(2) The carbonization of the rubber fiber is only in the shallow layer, which improves the bonding with the cement mortar while retaining the impact resistance of the rubber fiber. The modifiers for the secondary modification have low cost, simple operation, shortened modification time and saved energy consumption.

(3) The rubber fiber replaces a part of sand and gravels of an equal volume, which can not only increase the recycling rate of the waste rubber and slow down the pollution caused by the waste tires, but also reduce the amount of sand and gravels, protect the environment and reduce the manufacturing cost of pipe piles.

Comprehensively considering the demoulding strength, the ratio of tensile strength to compressive strength, the energy dissipation ratio, the failure strain and the failure mode of the concrete produced with various modification methods, it may be found that the effect of the dual modification method is stronger than that of the single modification method; and among the dual modification methods, the modification effects of the combination of “shallow carbonization” and “3% silane coupling agent” and the combination of “shallow carbonization” and “styrene-butadiene latex” are excellent. Among them, the modification effect of the combination of “shallow carbonization” and “3% silane coupling agent” is the best. This not only enables the compressive strength of the rubber-modified non-autoclaved pipe pile concrete to be increased, but also enables the impact toughness, the crack resistance and the impact resistance of the concrete to be improved.

Non-autoclaved curing process consumes less energy and significantly reduces carbon emissions than traditional autoclaved curing process. The recycled rubber fiber replaces part of fine sand in concrete in an equal volume, which improves the recycling rate of waste tires and reduces the amount of fine sand. Adding recycled rubber fibers to concrete can not only improve the brittleness of the non-autoclaved concrete, but also enable energy saving. The dual modification method provided by the present disclosure alleviates the problem of poor bonding at the interface between the rubber and cement mortar, and provides strong support for the application of the recycled rubber modified non-autoclaved concrete pipe piles and the popularization of new environment-friendly building materials.

Finally, it should be explained that the above embodiments are only used to illustrate the technical schemes of the present disclosure, but not to limit the scope of protection of the present disclosure. Rubber fibers have good crack resistance, and they are mainly adopted in the embodiments. However, although the present disclosure has been described in detail with reference to the preferred embodiments, it is understandable for those skill in the art that the technical schemes of the present disclosure may be modified or equivalently replaced (for example, the rubber fiber is replaced by rubber particles) without departing from the essence and scope of the technical schemes of the present disclosure.

What is claimed is:

1. An energy-saving and environment-friendly non-autoclaved pipe pile concrete with high impact resistance, raw materials of the concrete comprising a cementing material, sand and gravels, modified rubber fiber, water reducer and water;
wherein the cementing material comprises Portland cement and admixture; a content of the cementing material in the concrete is 400-500 kg/m³; the admixture comprises slag powder and silicon powder, a specific surface area of the slag powder is 400-450 m²/kg, a specific surface area of the silicon powder is 15-30 m²/kg, a content ratio of the slag power to the whole cementing material is 25-40% by mass, and a content ratio of the silicon power to the whole cementing material is 5-10% by mass;
a content of the sand and gravels in the concrete is 1784 kg/m³-1925 kg/m³, where a sand content of the sand and gravels is 31.6%-36.6%;
a content ratio of the water reducer to the whole cementing material is 1.0-1.5% by mass;
rubber fiber is obtained by mechanically cutting a waste rubber tire, the rubber fiber has a length-diameter ratio of 2-10, a diameter of 2 mm-10 mm, and a tensile strength of 20-25 MPa; the modified rubber fiber is added to replace the sand and gravels of an equal volume in aggregate, with a replacement rate of 5-20%; and the modified rubber fiber is obtained by making the rubber fiber undergo shadow carbonization and soaking the obtained rubber fiber with a modifier;
a water-cement ratio is 0.19-0.22;
the modified rubber fiber is prepared by a method including following steps:
(1) weighing a certain amount of rubber fiber, soaking the rubber fiber with in clear water to wash off impurities and additives on a surface of the rubber fiber, filtering and drying the rubber fiber;
(2) placing the dried rubber fiber into a vacuum tube type atmosphere furnace, introducing nitrogen to replace air within the furnace, rapidly raising a temperature to 300-400 degrees Celsius, and keeping the temperature for 10-30 min, then collecting, after cooling, the rubber fiber after shallow carbonization; and
(3) placing the rubber fiber after shallow carbonization into a prepared modifier material for soaking for a certain time, and collecting, after post-processing, the rubber fiber after secondary modification, that is, the modified rubber fiber;
the shallow carbonization means that a carbonization depth is 1/6-1/5 of a radius from the surface to a center of the rubber fiber; and
the modifier is one or more selected from NaOH, methanol, silane coupling agent and styrene-butadiene latex; and a time for the soaking is 12-24 h.

2. The energy-saving and environment-friendly non-autoclaved pipe pile concrete with high impact resistance of claim 1, wherein the water reducer is polycarboxylic acid slow-release water reducer, and a content ratio of the water reducer to the whole cementing material is 1.2% by mass;
the slag powder is S95-grade slag powder, the specific surface area of the slag powder is 412 m²/kg, and the content ratio of the slag powder to the whole cementing material is 30% by mass; the silicon powder is 98 silicon powder, the specific surface area of the silicon powder is 21 m²/kg, and the content ratio of the silicon power to the whole cementing material is 10% by mass.

3. The energy-saving and environment-friendly non-autoclaved pipe pile concrete with high impact resistance of claim 1, wherein the length-diameter ratio of the rubber fiber is 5, and the modified rubber fiber is added to replace the sand and gravels of an equal volume in the aggregate, with a replacement rate of 15%.

4. The energy-saving and environment-friendly non-autoclaved pipe pile concrete with high impact resistance of claim 1, wherein a mass concentration of NaOH solution is 2-8%; a mass concentration of methanol solution is 65-80%; the silane coupling agent is KH550, and a content ratio of added silane coupling agent to the rubber fiber is 2-5% by mass; the styrene-butadiene latex is hydroxyl styrene-butadiene latex, and a content ratio of added styrene-butadiene latex to the rubber fiber is 50%-150% by mass.

5. The energy-saving and environment-friendly non-autoclaved pipe pile concrete with high impact resistance of claim 4, wherein the silane coupling agent is KH550, and the content ratio of the added silane coupling agent to the rubber fiber is 3% by mass.

6. The energy-saving and environment-friendly non-autoclaved pipe pile concrete with high impact resistance of claim 4, wherein the styrene-butadiene latex is hydroxyl styrene-butadiene latex, and the content ratio of the added styrene-butadiene latex to the rubber fiber is 80% by mass.

7. The energy-saving and environment-friendly non-autoclaved pipe pile concrete with high impact resistance of claim 1, where the post-processing comprises washing and/or drying.

8. A method for preparing the energy-saving and environment-friendly non-autoclaved pipe pile concrete with high impact resistance of claim 1, comprising:
(1) drying the sand and gravels to make a water content of the sand and gravels lower than 2%;
(2) weighing the sand and gravels, Portland cement, slag powder, silicon powder, modified rubber fiber, water reducer and water, according to parts of the raw materials;
(3) pouring the sand and gravels, the Portland cement, the slag powder, the silicon powder and the modified rubber fiber weighed in step (2) into a mixer, and stirring evenly for 60-90 s;
(4) adding the weighed water reducer and water, and continuing to stir for 120-150 s;
(5) placing the obtained concrete into an iron mold, and standing in a shade for 5-8 h;
(6) placing the concrete obtained in step (5) into a steam pool with an initial temperature of 50 degrees Celsius, and then heating and maintaining a constant temperature environment for 12 h; and
(7) when the temperature of the steam pool drops, opening the pool and taking out the non-autoclaved concrete;
in the above preparation method, a curing time during which the non-autoclaved pipe pile concrete is cured with formwork is 12 h, curing of the concrete with formwork comprises a delaying curing phase, a temperature-increasing phase and a constant temperature phase, a duration of the delaying curing phase is not less than 5 h, a duration of the temperature-increasing phase is not less than 2 h; and a constant temperature of the constant temperature phase is 85-90 degrees Celsius, and a duration of the constant temperature phase is not less than 10 h.
